(19) United States
(12) Patent Application Publication
(10) Pub. No.: US 2002/0041604 A1
(43) Pub. Date: Apr. 11, 2002

(54) SDH MULTIPLEXER WITH AIM FACILITIES

(76) Inventor: STEPHEN PATRICK FERGUSON, COVENTRY (GB)

Correspondence Address: ALAN ISRAEL, ESQ, KIRSCHSTEIN, OTTINGER, ISRAEL &, SCHIFFMILLER, 489 FIFTH AVENUE, NEW YORK, NY, 100176105

(21) Appl. No.: 08/945,899

(22) PCT Filed: Feb. 25, 1997
(86) PCT No.: PCT/GB97/00521

(30) Foreign Application Priority Data
Mar. 4, 1996 (GB) 9604619.8

(51) Int. Cl. H04J 3/16; H04J 3/22

(52) U.S. Cl. 370/466; 370/536; 370/537

(57) ABSTRACT

A Synchronous Digital Hierarchy multiplexer includes an Asynchronous Transfer Mode inverse multiplexer. The multiplexer is typically associated with ATM rate adaption and may be included in a telecommunications system having at least one data path connected at one end to the inverse multiplexer, the data path being connected at the other end thereof to a further inverse multiplexer.

The present invention relates to the use of inverse multiplexing in association with the transmission of Asynchronous Transfer Mode (ATM) information over an Synchronous Digital Hierarchy (SDH) network. The concept of inverse multiplexing in this context is first described.

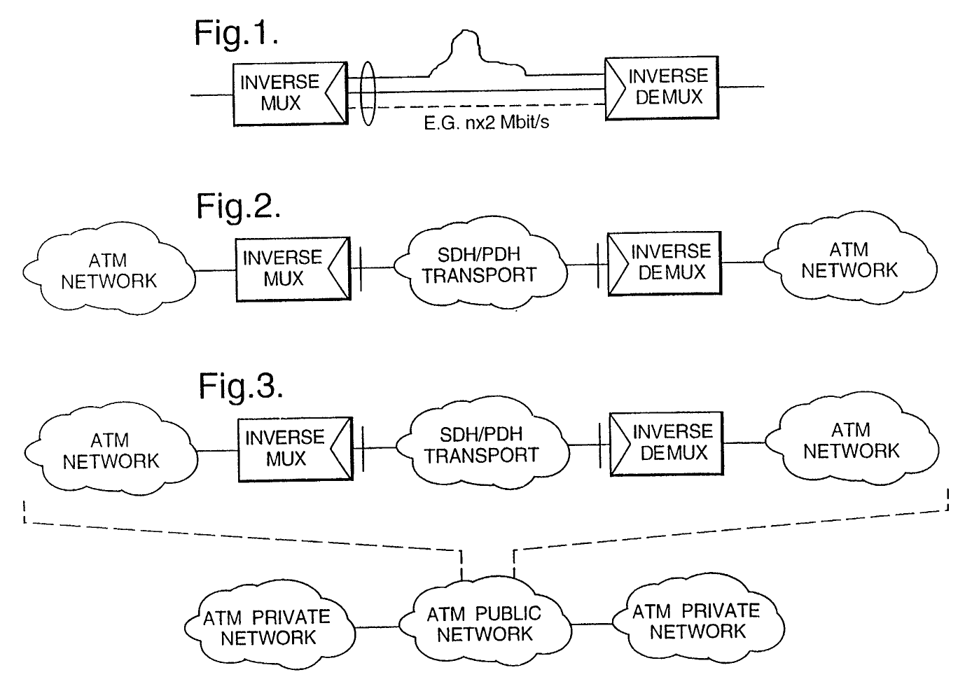

1. Inverse multiplexing adapts a serial data stream into multiple slower parallel streams for transport as shown in FIG. 1, and the demultiplexer reverses the process, also allowing for possible differences in path length and propagation delay between the parallel streams. The number of parallel paths can be varied by the network management according to demand. A spare path may provide 1:n protection.

2. An ATM inverse multiplexer (AIM) is being defined by the ATM Forum and is expected to be adopted by the International Telecommunications Union (ITU). In contrast to existing proprietary inverse multiplexers acting at bit level, for n×64 kbit/s and for n×2 Mbit/s, it standardises the adaption of a stream of any ATM cells into multiple parallel streams, each to be borne over circuits 1.5 or 2 Mbit/s.

3. AIMS are intended for use within an ATM network, providing an economic means of linking its sub-networks, typically via lines leased by one telephone company to another, in cases where high rate bearers such as 34/45 Mbit/s are uneconomic or unavailable. With AIMs, allocation of leased line capacity and therefore costs can rise incrementally with needs, rather than in big jumps. AIMs can allow Plesiochronous Digital Hierarchy (PDH) circuits to support SDH-like qualities, at least for ATM transport, because of the potential ability of AIMs to use 1:n sparing and to provide management information about the performance of each component parallel stream.

Network management in this application must ideally be able to track the multiple parallel streams as a single group. In SDH this concept is defined as “virtual concatenation”.

The statistical gain which ATM networks can potentially offer between users and applications, for some types of traffic, is not a feature of AIMs. Instead, any such gain would be arranged within each AIM network, with the AIMs providing an inherently peak-rate limited bearer pipe between such networks.

AIMs are expected to be implemented within ATM switches and the proposal is that they should be optionally included in SDH elements.

Existing forms of inverse multiplexing for data rates of Megabits per second (Mbit/s) are proprietary and do not conform to any standard. They exist as stand-alone boxes which can be fitted into a data network, typically converting between a Router port at up to 8 Mbit/s in the data network, and up to 4×2.048 Mbit/s physical links connected into the PDH transport network. At the far end data network an inverse multiplexer from the same vendor is used in a complementary manner. Within the PDH network, multiple 2 Mbit/s links are generally multiplexed up successively to 8 or 34 Mbit/s or 140 Mbit/s.

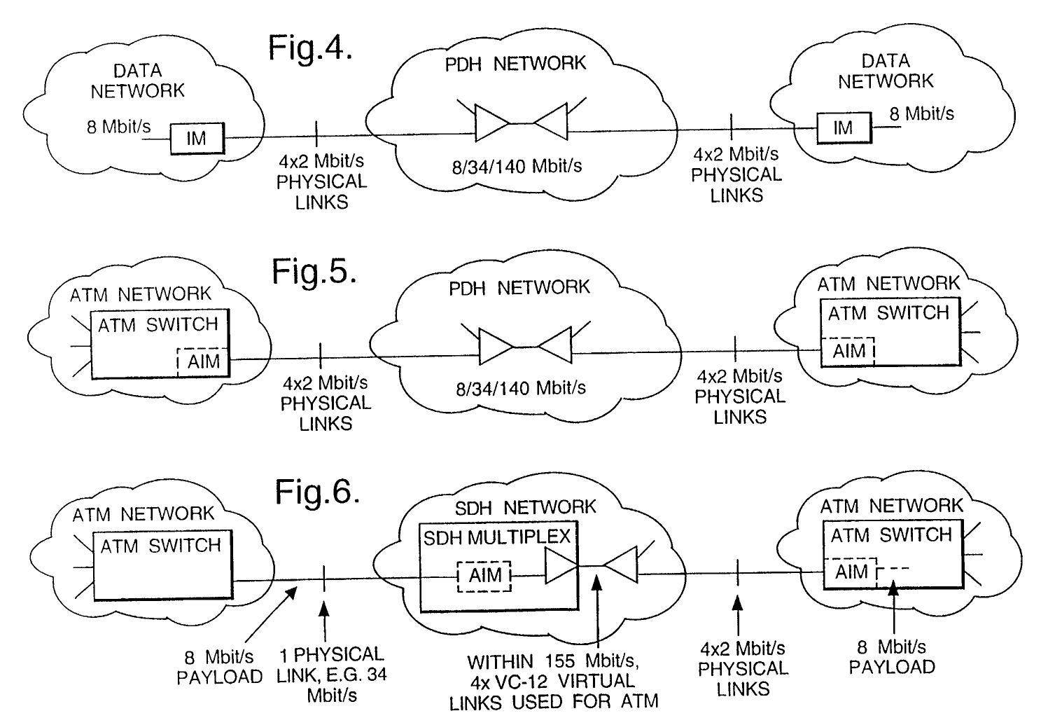

An ATM inverse multiplexer (“ATM”) function in accordance with ATM Forum specifications is expected to be supported by numerous suppliers, allowing much more flexible interworking between ATM networks. In particular, AIMs are intended, among other implementations in ATM products, to be embedded within ATM switches (see for example Cable Telecommunications Engineering, December 1995, p10 et seq). Such switches would typically have a number of port options, including 155 Mbit/s (SDH rate) and 34 or 2 Mbit/s (PDH rates). For commonality with FIG. 4, FIG. 5 shows ATM traffic at 8 Mbit/s being transported via 4×2 Mbit/s physical links, although the FIG. 4 could in principle be any integer figure. Although PDH includes the definition of an 8.448 Mbit/s rate, this rate is now little supported by product vendors, partly because it is not in turn transportable by SDH.

According to the present invention there is provided a Synchronous Digital Hierarchy (SDH) multiplexer including an Asynchronous Transfer Mode (ATM) inverse multiplexer function.

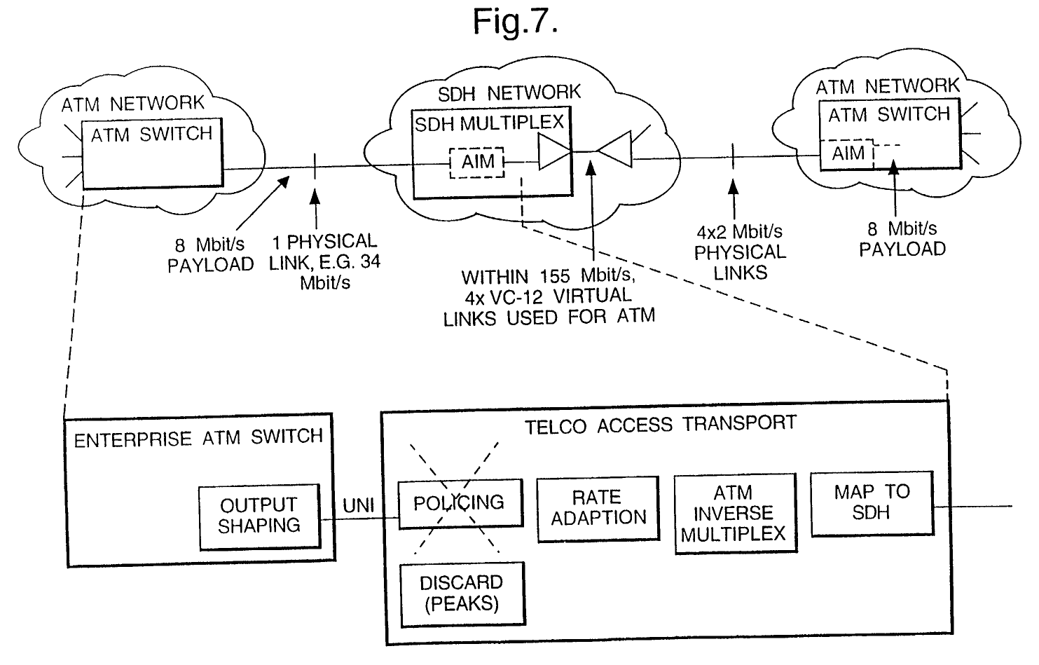

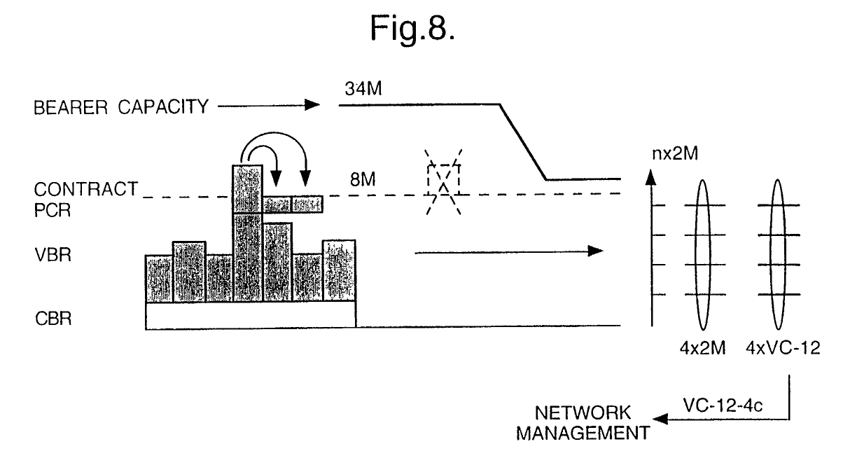

The SDH multiplexer would typically be associated with ATM rate adaption as shown in FIGS. 7 and 8.

The SDH multiplexer further includes means for converting between contiguous concatenation for 622 Mbit/s and virtual concatenation.

A corresponding inverse multiplexer for the complementary process would be needed at the far end of the data path and this could remain in its conventional position as shown.

These is further provided a parameter which is assigned to each User Network Interface Port and relates to multiple Virtual Paths.

The present invention will now be described, by way of example, with reference to the accompanying drawings in which:

FIG. 1 illustrates the principle of an inverse multiplexer;

FIG. 2 shows a block diagram of an ATM Inverse Multiplexer (AIM);

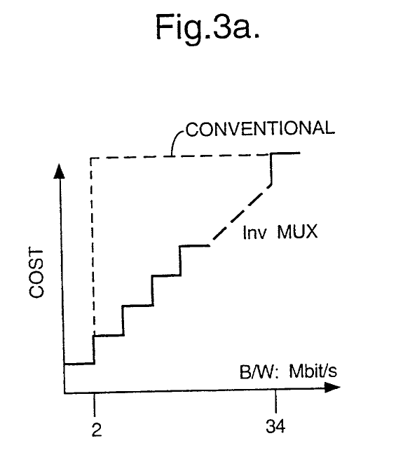

FIG. 3 shows the use of an AIM in an ATM network;

FIG. 3a illustrates the relationship between bandwidth and cost increments;

FIG. 4 shows a block diagram illustrating the application of a conventional inverse multiplexer;

FIG. 5 shows a block diagram illustrating the application of an AIM within an ATM switch;

FIG. 6 shows a block diagram illustrating the application of an AIM within an SDH element;

FIG. 7 shows a block diagram illustrating the processes before and after the AIM function in the FIG. 6; and

FIG. 8 shows the actions on ATM cells corresponding to the processes illustrated in FIG. 7.

An ATM inverse multiplexer function should be placed within an SDH multiplexer, i.e. not an ATM product, as shown in FIG. 6, and associated with ATM rate adaption as shown in FIGS. 7 and 8, also in the SDH multiplexer. This placement of the AIM within an SDH multiplexer gives operational advantages, plus the general advantage that the multiple physical interfaces of FIGS. 4 and 5 can now be replaced by a single physical interface between the ATM switch and the SDH multiplexer, with specific advantages which are expanded a little later. The design of a multiplexer such as the SDH one shown in FIG. 6 would generally use virtual parallel streams internally between the AIM and the normal SDH multiplexer function, i.e. such that those streams—of 2 Mbit/s for example—would typically be in the form of a single, multiplexed serial internal stream.

Whereas the AIM function within an ATM switch can typically be implemented in software, taking advantage of the switch's multiple PDH ports, its implementation in an SDH multiplexer could typically require additional hardware. Overall system cost savings should still occur because of the reduction in physical ports.

The manner of operation within the combined SDH multiplexer is next described. Within the SDH multiplexer, an 8 Mbit/s payload for example would be mapped into 4×2 Mbit/s, each 2 Mbit/s in turn then being mapped into an SDH virtual container (VC) of appropriate size (VC-12) for onward transmission. Alternatively, the ATM payload could be mapped directly and more efficiently into each of the SDH VC-12, allowing some of that payload to be carried by what otherwise would be “overhead” or control bytes for the mapping of each 2 Mbit/s into its VC-12. For illustration, the nominal size of VC-12. For illustration, the nominal size of a VC-12 is 2.304 Mbit/s and is used to carry “2 Mbit/s” or 2.048 Mbit/s. ITU recommendation define the mapping of an ATM cell stream into various VC-n: e.g. VC-2, VC-3 and VC-4.

Other traffic could of course be carried by the SDH multiplexer, within the remaining capacity of its (N×) 155 Mbit/s interface to the rest of the SDH network. The use of AIM allows the granularity—i.e. the smallest increment of bandwith allocation—of ATM bandwidth provision to be kept as small as necessary to tailor SDH network capacity to the various demands on it, both ATM and non-ATM.

SDH has defined within the concept of virtual concatenation, in which a number of otherwise independent VC-n are associated together purely by references stored in the SDH network management system. This may be done for example in order that they could be ensured of similar geographical routing to ensure propagation delays a group of VC-n, when used for AIM in the way described, could with advantage be managed as a virtual concatenation group. A set of m×VC-n would then be defined as “VC-n-mc” according to ITU.

The placing of the ATM inverse multiplexer in the SDH multiplexer gives the advantage that a single physical interface can be used between the ATM switch and the SDH multiplexer, carrying a variable payload with in the case shown is 8 Mbit/s, for consistency of illustration. Above 2 Mbit/s the next level in the accepted hierarchy of network interconnections for ATM transmission is 34 Mbit/s. The use of a single interface gives obvious savings in terms of the costs of cable and installation and of multiple ports on the equipments. It also gives greater operational flexibility to increase traffic levels without manual intervention, but the chief benefit of the arrangement is to the ATM switch, which now has more free ports for other applications.

This is significant because the capacity of an ATM switch is most commonly expressed in terms of its number of ports, each port being assumed as 155 Mbit/s. The number of ports on an ATM switch is typically a severe design and cost constraint with low speed ports being disproportionately expensive in relation to their speed. As an illustration, each card which carries 2 Mbit/s ports would typically carry 8 such ports and occupy the space of a card which could otherwise provide a 155 Mbit/s port, i.e. about 10 times as much traffic. Although special additional shelf designs can sometimes be provided within the ATM switch. In order to concentrate the traffic of many low speed ports into a single 155 Mbit/s port, they add significantly to cost and complexity.

Once an AIM is inside the SDH multiplexer, a further opportunity occurs. Reinterpreting FIG. 2 AIMS can alternatively be employed between end users, thereby allowing a managed SDH transport network to route single ATM circuits or groups of thee At the same time this approach can emulate one of the key attributes of an ATM network, that of supporting flexible bandwidth allocation, in this case in multiplex of 1.5/2 Mbit/s. This matches the needs of many ATM users and provides a low risk approach to the early provision of ATM leased lines because it uses existing SDH infrastructure rather than needing a new ATM one.

As a variation on the above arrangement an SDH multiplexer plus its associated AIM could be included in the ATM switch, so that the interface between switch and SDH network would be at a rate of (N×) 155 Mbit/s. Given the use of an AIM here the capacity used in that interface would be in increments of VC-n, such as VC-12 etc. rather than the usual single VC-n. A further proposal arises from this opportunity with particular advantage in the case of VC-4. The currently defined method of mapping ATM into SDH 622 Mbit/s is by “contiguous” concatenation referenced in ITU 1.432 in which multiple VC-4 (in this case four of them) are associated together via specific control byte contents in each of them, in fact in the “pointer” of each VC-4. The 4×VC-4 then appear as a single payload, with tightly controlled relative delays between them through the SDH equipments, and so with no need for AIM to be used across the 4×VC-4.

This method of concatenation has the advantage that no known SDH transmission equipment has in practice been designed to acknowledge the specific control bytes and act in accordance with them. Accordingly, current 622 Mbit/s ATM cannot be carried over existing SDH networks. Even if one SDH vendor were to support this mode, already installed SDH networks would be a barrier. In the USA where dark fibre is relatively common and available for the direct interconnection of ATM nodes, this is not a serious concern, but in Europe dark fibre is much less commonly made available.

Conversion may be carried out, for example within an SDH multiplexer wherever located—between the contiguous concatenation which is used for 622 Mbit/s, and the virtual concatenation which could in practice be supported by existing SDH equipment, since it imposes no new requirements on SDH network elements. This conversion would of course involve the application of AIM across the 4×VC-4 which are to be a virtual concatenation group. Although the value of 4 applies to 622 Mbit/s, other values could equally apply, for other data rates.

Corporate traffic will typically contain a mixture of Constant Bit Rate (CBR) and Variable Bit Rate (VBR) traffic. Each is constrained at the User Network Interface (UNI) by whatever Quality of Service (QoS) has been contracted with the telephone company on the basis that cells in excess of the agreed QoS profile will be put at risk of deletion by telephone company “policing” whenever the total load on the telephone company network is heavy. Idle cells which are used simply to fill the UNI are permitted to be deleted without reference to any QoS contract.

In order to stay within its contract, the corporation will be expected by the telephone company to provide output shaping, which should ideally anticipate the telephone company's policing and so may control more than one parameter of bursty cell flow, but should at least prevent the agreed Peak Cell Rate (PCR) from being exceeded typically by delaying any cells within excessive peaks.

Conventionally the QoS is defined per Virtual Container (VC) or per Virtual Path (VP) which may embrace multiple VCs. The QoS includes a number of parameters, some potentially complex and policing to verify that the QoS is being met imposes complex requirements on both hardware and software in the telephone company network. Where the contracted PCR is less than the UNI bearer, i.e. the transport path—can support then after policing a bearer of lower capacity per corporation can be used to economise on bandwith costs, perhaps by connecting more corporations to the access network. The Rate Adaption to a smaller bearer involves the deletion of idle cells.

A bearer of almost arbitrary size can be synthesised by ATM inverse multiplexing, which puts a serial cell stream through a number of parallel channels or hearers which are managed to form one compound bearer. The parallel channels may be at primary rate (1.5 or 2 Mbit/s) which may then be mapped into SDH or SONET payloads, or the ATM inverse multiplexing may be directly into SDH or SONET payloads.

To simplify the design of ATM access network products a simpler parameter than QoS may be defined to be assigned per UNI port—which may embrace multiple VP—and is associated particularly but not exclusively with the use of ATM inverse multiplexing into SDH.

1. Where the telephone company provides a Virtual Path service, QoS will be managed at the VP level. Through each VP a corporation can choose to tunnel a quantity of Switched Virtual Circuits to its other sites. It is then up to the corporation to police its own SVC such that within a VP which is passed to the telephone company, no “greedy” SVC will launch so many cells that it prevents a fair share of capacity being available to other SVC. This policing function occurs within the Enterprise switch. If it should fail, perhaps because of equipment faults, then the presence of telephone company policing at VP level, which cannot distinguish between the cells of different SVCs may disrupt some of the corporation's SVCs between its sites.

2. In the Enterprise switch traffic shaping at the output adapts its Peak Cell Rate to the physical port rate option provided such as 34 or 155 Mbit/s UNI. This shaping typically results in extra of cells within any excessive peaks. In order that delay-sensitive traffic such as CBR can be protected shaping can be applied independently to each VP in such a way that the total cell rate is held within the UNI physical rate. If this shaping should fail, perhaps because of equipment faults, then the inherent physical limit on the UNI rate may cause disruption to some of the corporation's VPs between its sites.

3. Output traffic shaping further allows for PCR lower than the port rate to be defined, in order to permit more flexible dimensioning of the supporting network. (Usually it is only in this application that the existence of “output shaping” is acknowledged through clearly it must also exist in order to allow different port rate options to be supported). Such shaping can be applied independently to each VP in such a way that the total cell rate is held within the PCR limit. This potentially allows the telephone company to simplify its access network management and planning, by configuring just one input parameter for each ATM UNI port, i.e. its limiting PCR rather than configuring typically 6-12 QoS parameters for each of up to 356 VP upper port as allowed by the UNI definition in ITU.

The contract between telephone company and corporation would then state that the latter must not exceed its port PCR. If it should fail, perhaps because of equipment faults, then the presence of telephone company limiting at PCR per port may disrupt some of the corporation's VPs between its sites. This latter possibility is no worse a hazard than described in (2) above as a consequence of possible equipment failure.

Acceptance of this simplified access parameter definition per UNI port would simplify network operations and reduce the complexity of ATM access equipment, but not introduce any new hazard to quality of service.

1. A Synchronous Digital Hierachy (SDH) multiplexer including an Asynchronous Transfer Mode (ATM) inverse multiplexer (AIM).

2. An SDH multiplexer as claimed in claim 1 and employing ATM rate adaption.

3. An SDH multiplexer as claimed in claim 1 or 2, and further including means for converting between contiguous concatenation for 622 Mbit/s and virtual concatenation.

4. A telecommunications system including an SDH multiplexer as claimed in any preceding claim, having at least one data path, connected at one end to the AIM, the data path being connected at the other end thereof to a further AIM.

5. A telecommunications system as claimed in claim 4, further comprising a plurality of ATM User Network Interface (UNI) ports and comprising means providing an input parameter for each UNI port.

6. A telecommunications system as claimed in claim 5, wherein each UNI port includes one or more Virtual Paths.
